(19) United States
(12) Patent Application Publication
(10) Pub. No.: US 2017/0263031 A1
(43) Pub. Date: Sep. 14, 2017

(54) BODY VISUALIZATION SYSTEM

(71) Applicant: Trendage, Inc., Santa Clara, CA (US)

(72) Inventor: Vineet Chaudhary, Milpitas, CA (US)

(21) Appl. No.: 15/448,453

(22) Filed: Mar. 2, 2017

Related U.S. Application Data
(60) Provisional application No. 62/306,055, filed on Mar. 9, 2016.

(51) Int. Cl. G06T 11/60; G06T 11/00

(52) U.S. Cl. CPC G06T 11/60; G06T 11/001

(57) ABSTRACT

Body visualization can include: providing a store of body images depicting a variety of body types; selecting a body image from the store and displaying the body image to a user; and obtaining a set of user inputs from the user and visually altering the body image in response to the user inputs.

### CROSS-REFERENCE TO RELATED APPLICATIONS

This application claims priority from U.S. Provisional Application No. 62/306,055, filed on 9 Mar. 2016, entitled “Customizing A Digital Body And Overlaying Images of Apparel, Footwear and Accessories”. Application No. 62/306,055 is incorporated by reference herein, in its entirety, for all purposes.

### BACKGROUND

A computing system may be used to generate a digital body image. A computing system can prompt a user to enter a set of body measurements and the computing system can generate a digital body image based on the entered body measurements. For example, a computing system for displaying apparel on a digital body image can prompt a user to enter measurements of their height, weight, arms, torso, legs, etc., and then generate a digital body having those measurements for displaying apparel to the user.

### SUMMARY

In general, in one aspect, the invention relates to a body visualization system. The body visualization system can include: a store of body images depicting a variety of body types; a body image selector that obtains a body image from the store and displays the body image on a display; and a body image manipulator that enables a user to visually alter the body image on the display.

In general, in another aspect, the invention relates to a method for body visualization. The method can include: providing a store of body images depicting a variety of body types; selecting a body image from the store and displaying the body image to a user; and obtaining a set of user inputs from the user and visually altering the body image in response to the user inputs.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a body visualization system in one or more embodiments.

FIG. 2 shows an embodiment of a body visualization system in which a body image is selected from a store in response to a set of descriptive parameters.

FIGS. 3A-3C show how a body visualization system in one or more embodiments enables a user to alter a waistline depicted in a body image.

FIGS. 4A-4C show how a body visualization system in one or more embodiments enables a user to alter a height depicted in a body image.

FIGS. 5A-5C show how a body visualization system in one or more embodiments enables a user to alter the thickness of arms depicted in a body image.

FIGS. 6A-6C show how a body visualization system in one or more embodiments enables a user to alter the size of a face depicted in a body image.

FIGS. 7A-7C show how a body visualization system in one or more embodiments enables a user to alter a hairstyle depicted in a body image.

FIG. 8 shows an embodiment of a body visualization system that includes a mobile app running on a mobile computing device.

FIG. 9 illustrates a method for body visualization in one or more embodiments.

FIG. 10 illustrates a computing system upon which portions of a body visualization system can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

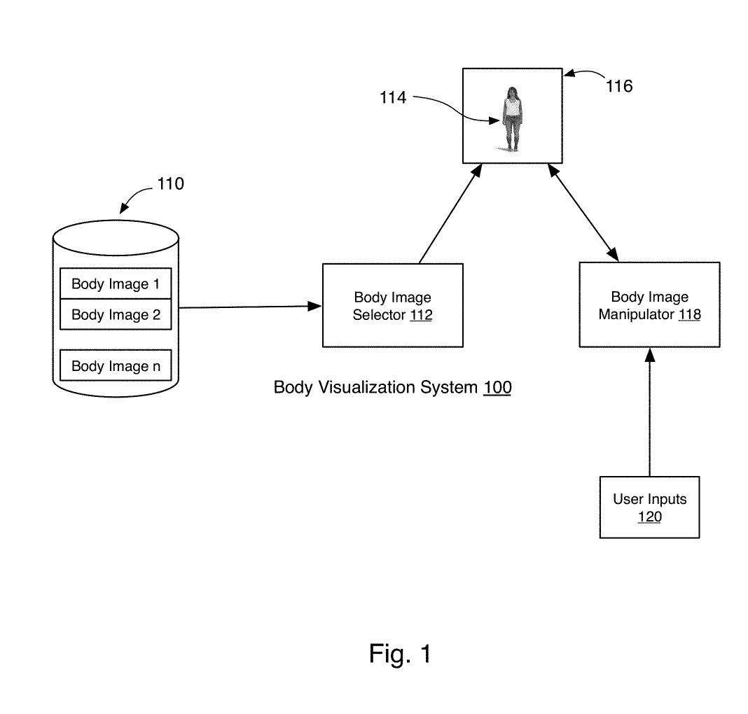

FIG. 1 shows a body visualization system 100 in one or more embodiments. The body visualization system 100 includes a store 110 of body images 1-n. The body images 1-n depict a variety of body types. The body types depicted by the body images 1-n can vary in a variety of ways, e.g., relative dimensions of legs, arms, hips, neck, face, calves, shoulders, waistline, etc. In one or more embodiments, each body image 1-n is a digital picture including an array of pixels of color data.

The body visualization system 100 includes a body image selector 112 that obtains a body image 114 from the store 110 and displays the body image 114 on a display 116. For example, the display 116 can be a display screen of a computer system, e.g., personal computer, laptop, etc., a display screen of a mobile device, e.g., a smartphone, tablet, wearable device, etc., a display screen of a kiosk, etc., in a public venue.

The body visualization system 100 includes a body image manipulator 118 that enables a user to visually alter the body image 114 on the display 116 in real-time by providing a set of user inputs 120. For example, the user inputs 120 can be obtained via a user interface mechanism of a computer system, e.g., personal computer, laptop, etc., a user interface mechanism of a mobile device, e.g., a smartphone, tablet, wearable device, etc., a user interface mechanism of a kiosk in a public venue, etc.

In one or more embodiments, the body image manipulator 118 visually alters the arms depicted in the body image 114 in response to the user inputs 120. For example, the user inputs 120 can cause the body image manipulator 118 to increase or decrease the width of the arms, increase or decrease the length of the arms, alter the shapes of the arms, etc.

In one or more embodiments, the body image manipulator 118 visually alters the legs depicted in the body image 114 in response to the user inputs 120. For example, the user inputs 120 can cause the body image manipulator 118 to increase or decrease the width of the legs, increase or decrease the length of the legs, alter the shape of the legs, etc.

In one or more embodiments, the body image manipulator 118 visually alters the hips depicted in the body image 114 in response to the user inputs 120. For example, the user inputs 120 can cause the body image manipulator 118 to increase or decrease the size of the hips, alter the shape of the hips, etc.

In one or more embodiments, the body image manipulator 118 visually alters the neck depicted in the body image 114 in response to the user inputs 120. For example, the user inputs 120 can cause the body image manipulator 118 to increase or decrease the length, width of the neck, alter the shape of the neck, etc.

In one or more embodiments, the body image manipulator 118 visually alters the face depicted in the body image 114 in response to the user inputs 120. For example, the user inputs 120 can cause the body image manipulator 118 to increase or decrease the size of the face.

In one or more embodiments, the body image manipulator 118 visually alters the calves depicted in the body image 114 in response to the user inputs 120. For example, the user inputs 120 can cause the body image manipulator 118 to increase or decrease the length, width of the calves, alter the shape of the calves, etc.

In one or more embodiments, the body image manipulator 118 visually alters the shoulders depicted in the body image 114 in response to the user inputs 120. For example, the user inputs 120 can cause the body image manipulator 118 to increase or decrease the size of the shoulders, alter the shape of the shoulders, etc.

In one or more embodiments, the body image manipulator 118 visually alters the waistline depicted in the body image 114 in response to the user inputs 120. For example, the user inputs 120 can cause the body image manipulator 118 to increase or decrease the waistline, alter the shape of the waistline, etc.

In one or more embodiments, the body visualization system 100 can generate sliders, wheels, buttons, etc., on the display 116 that enable a user to provide the user inputs 120 for selectively altering, visually, the legs, arms, hips, neck, face, calves, shoulders, waistlines, etc., of the body image 114 depicted on the display 116.

In one or more embodiments, the body image manipulator 118 visually alters the skin tone depicted in the body image 114 in response to the user inputs 120. For example, the body visualization system 100 can generate user interface elements, e.g., sliders, wheels, buttons, etc., on the display 116 that enable a user to selectively alter skin tone.

In one or more embodiments, the body image manipulator 118 adds wearable items to the body image 114 depicted on the display 116 in response to the user inputs 120. Examples of wearable items can include apparel, footwear, accessories, etc. For example, the body visualization system 100 can generate user interface elements, e.g., catalogues, links to catalogues, buttons, etc., on the display 116 that enable a user to selectively add apparel, footwear, accessories, etc., to the body image 114 depicted on the display 116.

The body image manipulator 118 can adapt the dimensions of wearable items selected by the user to the current dimensions of the body image 114 depicted on the display 116 when the adding wearable items. When the user visually alters the legs, arms, hips, neck, face, calves, shoulders, waistlines, etc., of the body image 114 via the user inputs 120, the body image manipulator 118 can adapt the dimensions of wearable items currently depicted on the body image 114 accordingly.

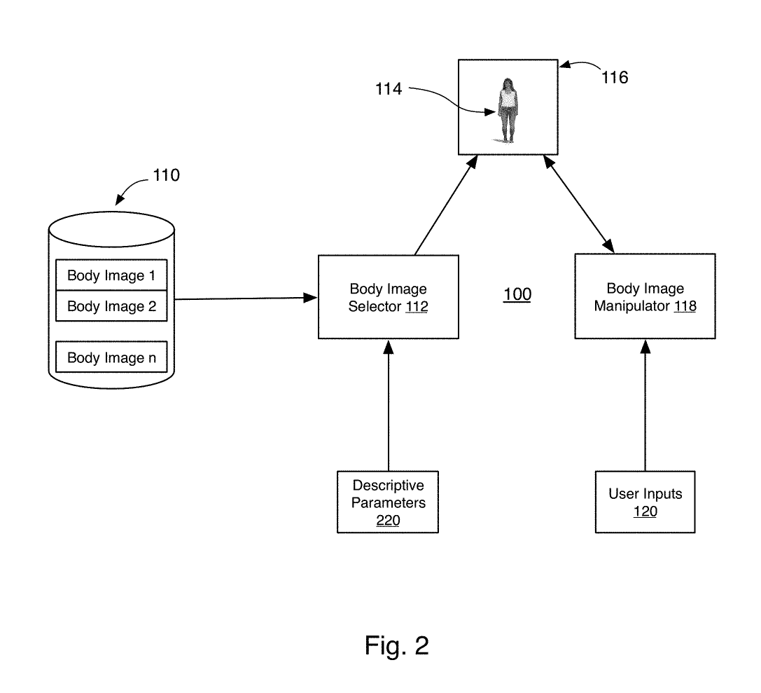

FIG. 2 shows an embodiment of the body visualization system 100 in which the body image selector 112 selects the body image 114 from among the body images 1-n in the store 110 by prompting a user to enter a set of descriptive parameters 220. For example, the body image selector 112 can prompt a user to enter the descriptive parameters 220 via a user interface mechanism of a computer system, e.g., personal computer, laptop, etc., a user interface mechanism of a mobile device, e.g., a smartphone, tablet, wearable device, etc., or a user interface mechanism of a kiosk, etc.

In one or more embodiments, the descriptive parameters 220 include a body weight and a body height. In one or more embodiments, each body image 1-n corresponds to a body weight/height data pair and the body image selector 112 maps the descriptive parameters 220 to the body image 1-n having the closest pertinent body weight/height data pair. For example, the body images 1-n for relatively high body weights and short body heights can be depict relatively short and wide body types whereas the body images 1-n for relatively low body weights and tall body heights can be depict relatively tall and thin body types.

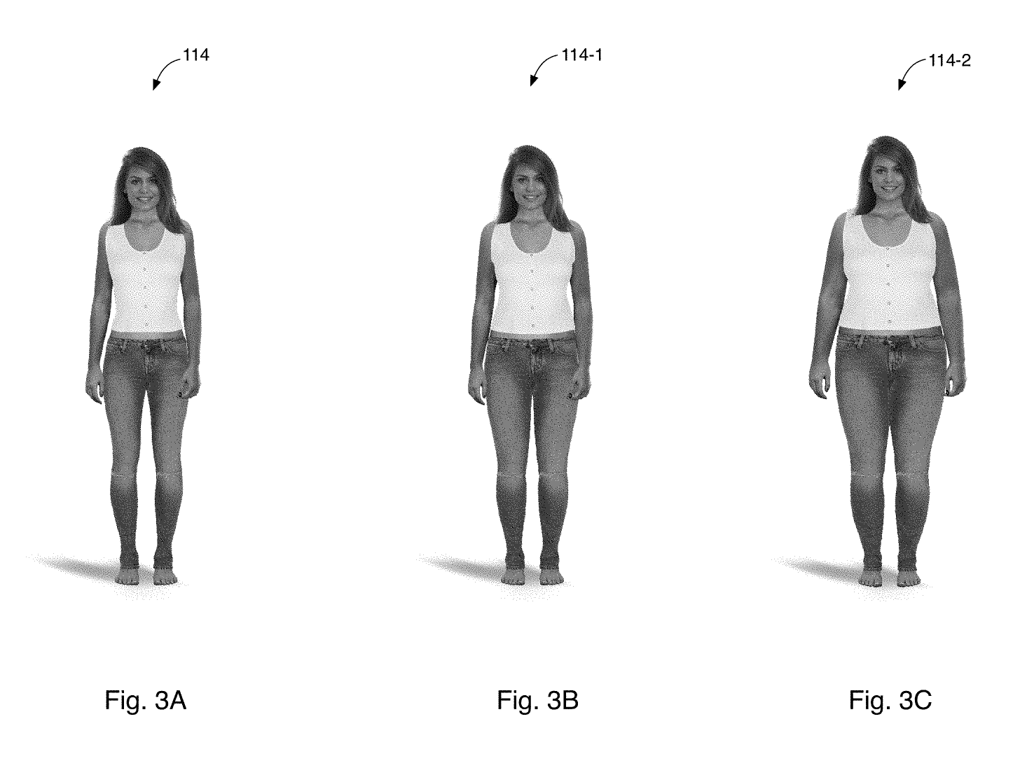

FIGS. 3A-3C show how the body image manipulator 118 enables a user to alter a waistline depicted in the body image 114. For example, the body visualization system 100 can generate user interface elements, e.g., a slider, a wheel, buttons, etc., on the display 116 that enable a user to selectively increase or decrease the waistline of a body image currently being displayed on the display 116. FIG. 3A shows the body image 114 as retrieved from the store 110 based on the descriptive parameters 220.

FIG. 3B shows how the body image manipulator 118 has altered the body image 114 into the body image 114-1 in response to the user inputs 120 indicating an increase to the waistline of the body image 114. In this example, the body image manipulator 118 increases the widths of the arms, legs, hips, calves, etc., depicted in the body image 114-1 from those of the body image 114 in accordance with the increase in the waistline indicated by the user.

FIG. 3C shows how the body image manipulator 118 has altered the body image 114-1 into the body image 114-2 in response to the user inputs 120 indicating an increase to the waistline of the body image 114-1. The body image manipulator 118 increases the widths of the arms, legs, hips, calves, etc., depicted in the body image 114-2 in accordance with the further increase in the waistline indicated by the user.

The body image manipulator 118 can increase the widths of the arms, legs, hips, calves, etc., depicted in a body image by replicating pixels. For example, the body image manipulator 118 can increase the widths of the arms depicted in the body image 114 by replicating pixels from the existing arms and adding the replicated pixels to the contours of the arms. The body image manipulator 118 can employ image smoothing, lighting techniques, etc., to provide a natural look to the increased arm width.

The body image manipulator 118 can decrease the widths of the arms, legs, hips, calves, etc., depicted in a body image by eliminating pixels. For example, the body image manipulator 118 can decrease the widths of the arms depicted in the body image 114 by shaving pixels from the contours of existing arms and replacing the shaved pixels with background pixels. The body image manipulator 118 can employ image smoothing, lighting techniques, etc., to provide a natural look to the decreased arm width.

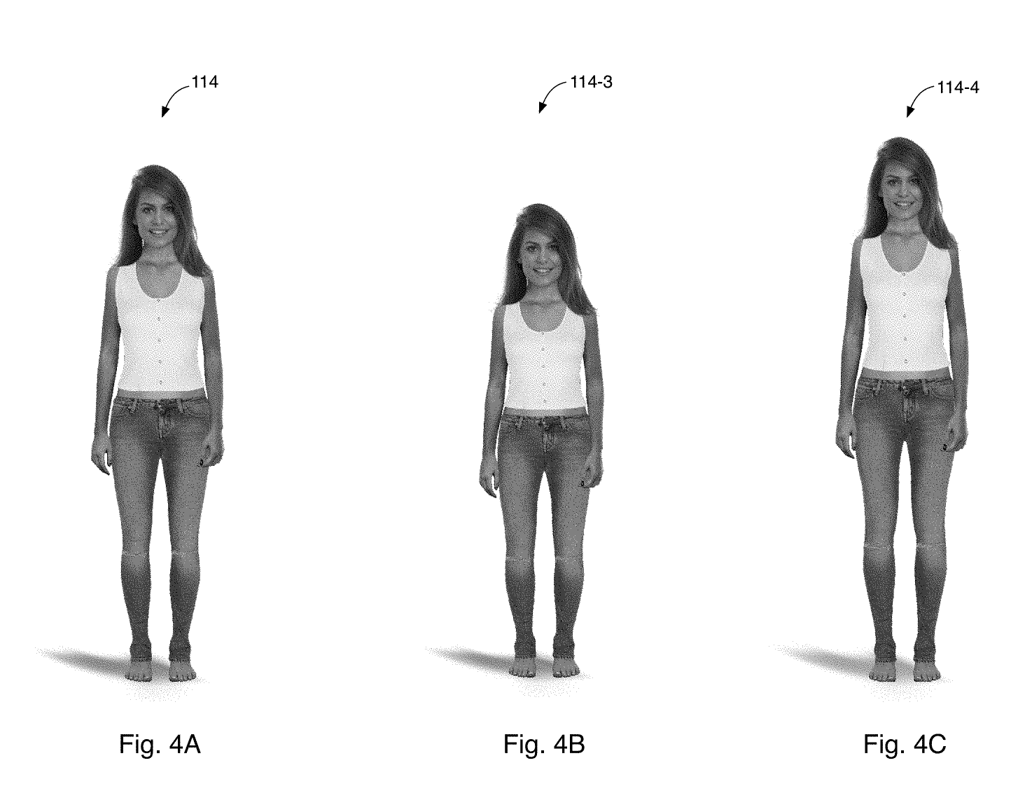

FIGS. 4A-4C show how the body image manipulator 118 enables a user to alter a height depicted in the body image 114. For example, the body visualization system 100 can generate user interface elements, e.g., a slider, a wheel, buttons, etc., on the display 116 that enable a user to selectively increase or decrease the height depicted in a body image currently being displayed on the display 116. FIG. 4A shows the body image 114 as retrieved from the store 110 based on the descriptive parameters 220.

FIG. 4B shows how the body image manipulator 118 has altered the body image 114 into the body image 114-3 in response to the user inputs 120 indicating a decrease in height, e.g., a decrease in inseam measurement. The body image manipulator 118 decreases the lengths of the arms, legs, calves, torso, etc., depicted in the body image 114-3 from those of the body image 114 in accordance with the decrease in height indicated by the user.

FIG. 4C shows how the body image manipulator 118 has altered the body image 114-3 into the body image 114-4 in response to the user inputs 120 indicating an increase to the height of the body image 114-3. The body image manipulator 118 increases the lengths of the arms, legs, calves, torso, etc., depicted in the body image 114-4 from those of the body image 114-3 in accordance with the increase in height indicated by the user.

The body image manipulator 118 can increase the lengths of the arms, legs, calves, torso, etc., depicted in a body image by replicating pixels. For example, the body image manipulator 118 can increase the lengths of the arms depicted in the body image 114 by replicating horizontal lines of pixels from the existing arms. The body image manipulator 118 can employ image smoothing, lighting techniques, etc., to provide a natural look to the increased arm length.

The body image manipulator 118 can decrease the lengths of the arms, legs, calves, torso, etc., depicted in a body image by eliminating pixels. For example, the body image manipulator 118 can decrease the lengths of the arms depicted in the body image 114 by eliminating lines of pixels from the existing arms and adding background pixels. The body image manipulator 118 can employ image smoothing, lighting techniques, etc., to provide a natural look to the decreased arm length.

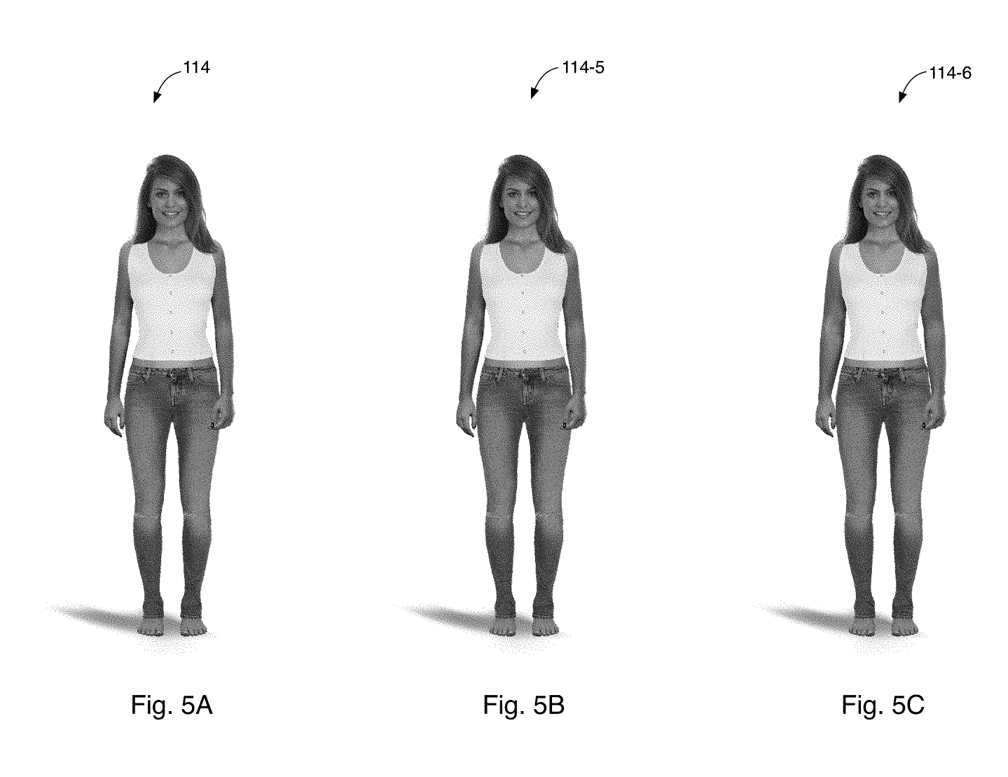

FIGS. 5A-5C show how the body image manipulator 118 enables a user to alter the thickness of arms depicted in the body image 114. For example, the body visualization system 100 can generate user interface elements, e.g., a slider, a wheel, buttons, etc., on the display 116 that enable a user to selectively increase and decrease the thickness of the arms depicted in a body image currently being displayed on the display 116. FIG. 5A shows the body image 114 as retrieved from the store 110 based on the descriptive parameters 220.

FIG. 5B shows how the body image manipulator 118 has altered the body image 114 into the body image 114-5 in response to the user inputs 120 indicating an increase in arm thickness of the body image 114. The body image manipulator 118 increases the thickness of the arms depicted in the body image 114-5 from that of the body image 114 in accordance with the increase indicated by the user.

FIG. 5C shows how the body image manipulator 118 has altered the body image 114-5 into the body image 114-6 in response to the user inputs 120 indicating an increase to the arm thickness of the body image 114-5. The body image manipulator 118 increases the thickness of the arms depicted in the body image 114-6 from that of the body image 114-5 in accordance with the increase indicated by the user.

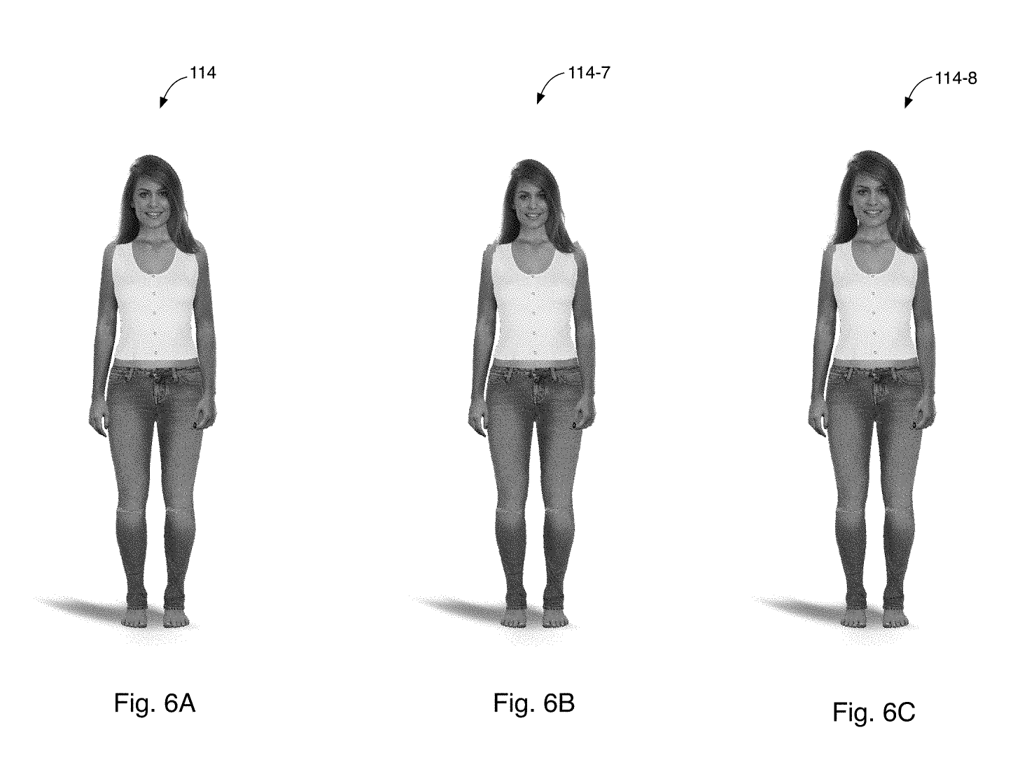

FIGS. 6A-6C show how the body image manipulator 118 enables a user to alter the size of a face depicted in the body image 114. For example, the body visualization system 100 can generate user interface elements, e.g., a slider, a wheel, buttons, etc., on the display 116 that enable a user to selectively increase or decrease the size of a face depicted in a body image currently being displayed on the display 116. FIG. 6A shows the body image 114 as retrieved from the store 110 based on the descriptive parameters 220.

FIG. 6B shows how the body image manipulator 118 has altered the body image 114 into the body image 114-7 in response to the user inputs 120 indicating a decrease in face size. The body image manipulator 118 decreases the size of the face depicted in the body image 114-7 from that of the body image 114 in accordance with the decrease indicated by the user.

FIG. 6C shows how the body image manipulator 118 has altered the body image 114-7 into the body image 114-8 in response to the user inputs 120 indicating an increase in face size. The body image manipulator 118 increases the size of the face depicted in the body image 114-8 from that of the body image 114-7 in accordance with the increase indicated by the user.

The body image manipulator 118 can increase the size of a face depicted in a body image by replicating pixels throughout the face while maintaining the proportionality of facial features. The body image manipulator 118 can employ image smoothing, lighting techniques, etc., to provide a natural look to the increased face size.

The body image manipulator 118 can decrease the size of a face depicted in a body image by eliminating pixels throughout the face while maintaining the proportionality of facial features and adding background pixels. The body image manipulator 118 can employ image smoothing, lighting techniques, etc., to provide a natural look to the decreased face size.

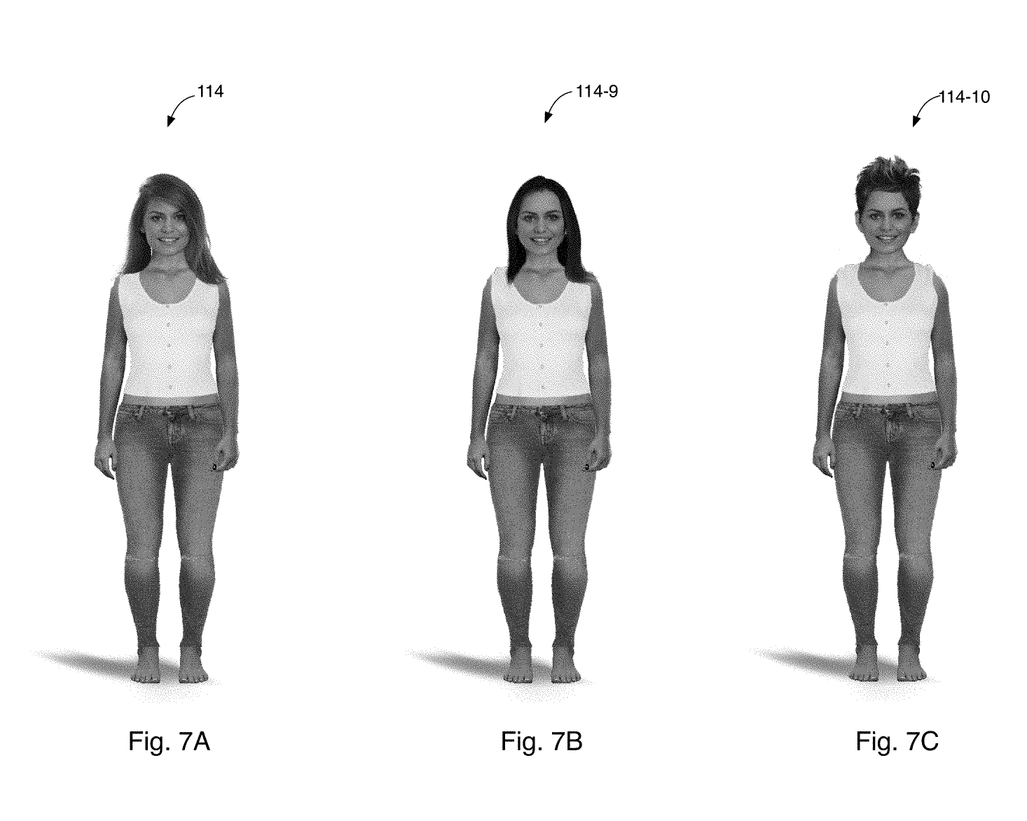

FIGS. 7A-7C show how the body image manipulator 118 enables a user to alter a hairstyle depicted in the body image 114. For example, the body visualization system 100 can generate user interface elements, e.g., a selection of images of hairstyles, buttons, etc., on the display 116 that enable a user to select a hairstyle for a body image currently being displayed on the display 116. FIG. 6A shows the body image 114 as retrieved from the store 110 based on the descriptive parameters 220 with a default hairstyle.

FIG. 7B shows how the body image manipulator 118 has altered the body image 114 into the body image 114-9 in response to the user inputs 120 indicating a selected hairstyle. FIG. 7C shows how the body image manipulator 118 has altered the body image 114-9 into the body image 114-10 in response to the user inputs 120 indicating a new selected hairstyle.

The body image manipulator 118 can alter a hairstyle of a body image by segmenting pixels of the body image depicting the face from pixels depicting the hairstyle in the body image 114. The body image manipulator 118 can adjust the size of the new hairstyle to fit the current dimension of the face depicted on the body image. The body image manipulator 118 can add face pixels for newly visible face areas of a new hairstyle.

In one or more embodiments, the body image manipulator 118 enables a user to alter a background for the body image 114. For example, the body visualization system 100 can generate user interface elements, e.g., a selection of backgrounds, locations, venues, buttons, etc., on the display 116 that enable a user to select a background for a body image currently being displayed on the display 116.

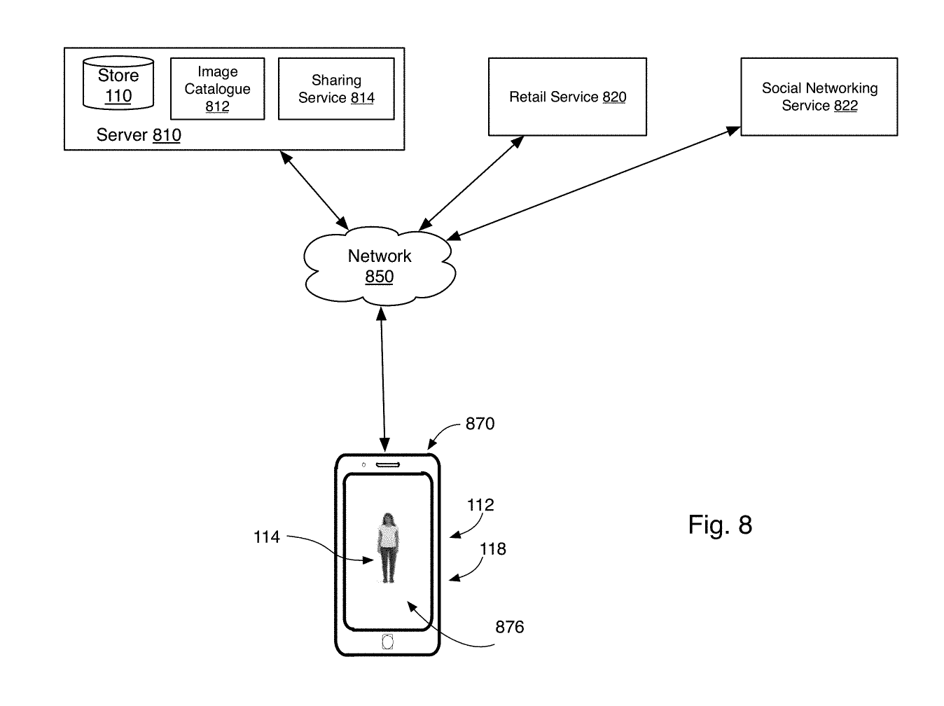

FIG. 8 shows an embodiment of the body visualization system 100 in which the store 110 of body images 1-n is located on a cloud-based server 810 accessible via a network 850 and the body image selector 112 and the body image manipulator 118 are implemented on code on a mobile computing device 870. In one or more embodiments, the mobile computing device 870 runs a body visualization mobile app that includes the functions of the body image selector 112 and the body image manipulator 118.

The body visualization mobile app on the mobile computing device 870 can obtain the body image 114 from the store 110 on the server 810 via the network 850 using Internet protocols. The body visualization mobile app on the mobile computing device 870 can obtain the user inputs 120 and the descriptive parameters 220 from a user via a touchscreen 876 of the mobile computing device 870.

In one or more embodiments, the body visualization mobile app on the mobile computing device 870 can obtain images of wearable items, e.g., apparel, footwear, accessories, etc., and background images, hairstyles, etc., from an image catalogue 812 on the server 810.

In one or more embodiments, the body visualization mobile app on the mobile computing device 870 can obtain images of wearable items, e.g., apparel, footwear, accessories, etc., from a retail service 820 via the network 820. The body visualization mobile app on the mobile computing device 870 can enable a user to preview possible purchases from the retail service 820 on their own custom body image on their mobile computer device 870 with a variety of hairstyles, looks, background locations, etc.

In one or more embodiments, the body visualization mobile app on the mobile computing device 870 can access a sharing service 814 on the server 810. For example, the sharing service 814 can enable a user of the mobile computing device 870 to share body images they create using the body visualization mobile app with other users. The sharing service 814 can enable users to post comments, provide feedback to postings, create ranking, trends, etc.

In one or more embodiments, the body visualization mobile app on the mobile computing device 870 enables its user to share body images they create using the body visualization mobile app on a social networking service 822, e.g., a widely used public social network.

In one or more embodiments, the body visualization mobile app on the mobile computing device 870 can acquire a picture of an individual, e.g., a selfie of a user, segment a face in the picture from its background and body, and combine the acquired face onto the body image 114.

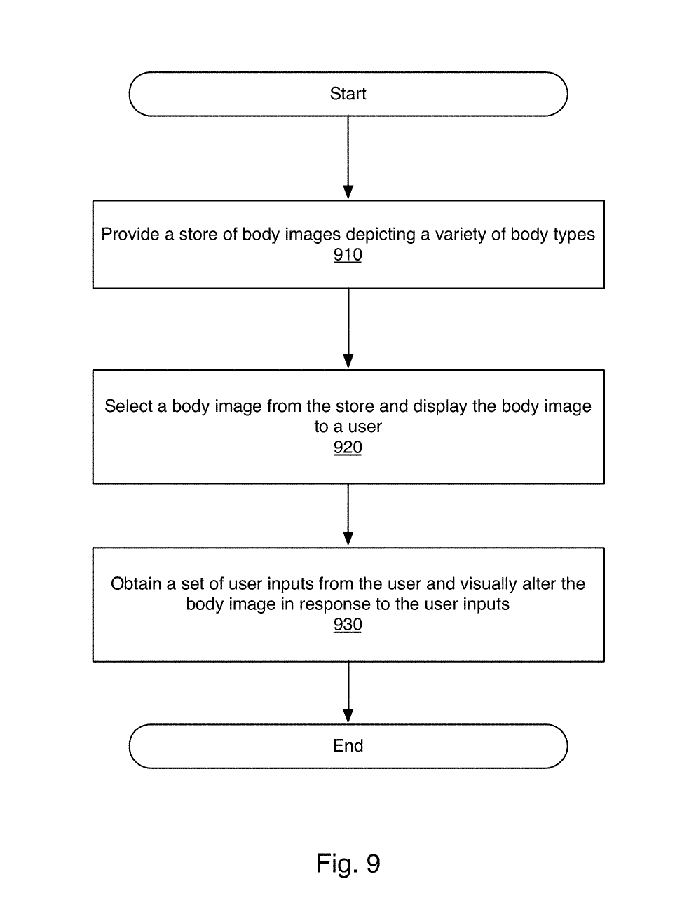

FIG. 9 illustrates a method for body visualization in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 9 should not be construed as limiting the scope of the invention.

At step 910, a store of body images depicting a variety of body types is provided. The body images in the store can be digital color pictures each adapted to depict a corresponding body weight/height combination.

At step 920, a body image is selected from the store and the body image is displayed to a user. The body image can be selected from the store based on a set of descriptive parameters obtained from the user. The nature of the descriptive parameters can be selected such that the parameters are likely to be known by the user, e.g., their own height and weight.

At step 930, a set of user inputs is obtained from the user and the body image is visually altered in response to the user inputs. Visual altering can include altering the relative dimensions of legs, arms, hips, neck, face, calves, shoulders, waistline, etc., of the body image, altering the face depicted on the body image, adding wearable items to the body image, changing a hairstyle or background, venue, depicted with the body image, etc.

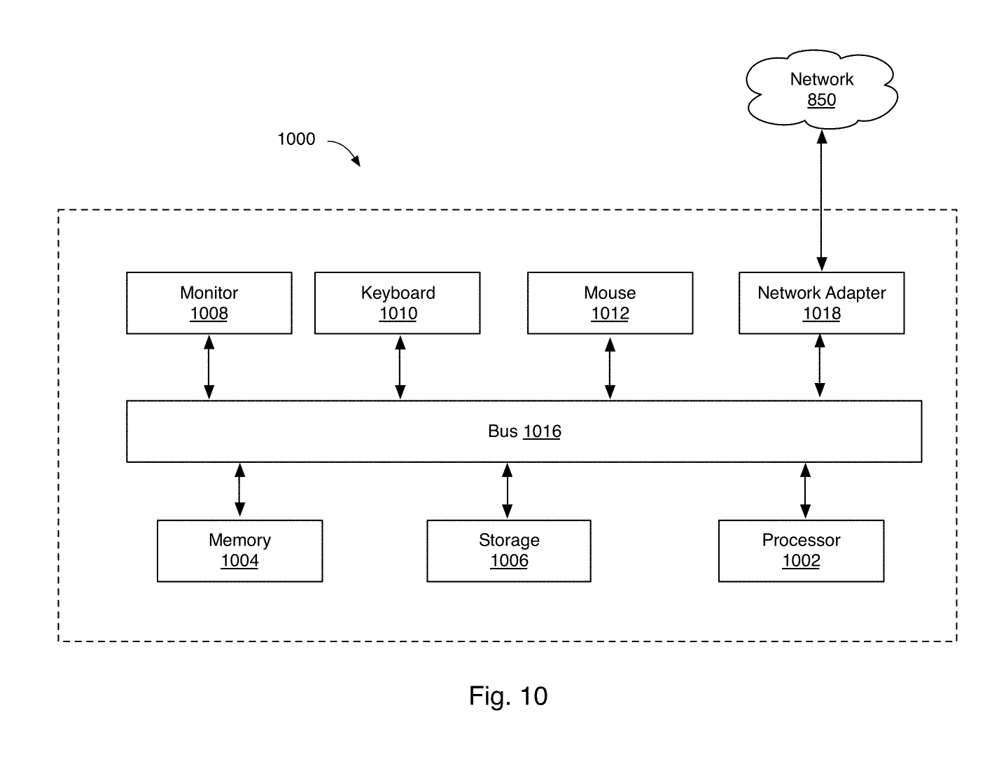

FIG. 10 illustrates a computing system 1000 upon which portions of the body visualization system 100 can be implemented. The computing system 1000 includes one or more computer processor(s) 1002, associated memory 1004 (e.g., random access memory (RAM), cache memory, flash memory, etc.), one or more storage device(s) 1006 (e.g., a hard disk, an optical drive such as a compact disk (CD) drive or digital versatile disk (DVD) drive, a flash memory stick, etc.), a bus 1016, and numerous other elements and functionalities. The computer processor(s) 1002 may be an integrated circuit for processing instructions. For example, the computer processor(s) may be one or more cores or micro-cores of a processor. The computing system 1000 may also include one or more input device(s), e.g., a touchscreen, keyboard 1010, mouse 1012, microphone, touchpad, electronic pen, or any other type of input device. Further, the computing system 1000 may include one or more monitor device(s) 1008, such as a screen (e.g., a liquid crystal display (LCD), a plasma display, touchscreen, cathode ray tube (CRT) monitor, projector, or other display device), external storage, input for an electric instrument, or any other output device. The computing system 1000 may be connected to the network 850 (e.g., a local area network (LAN), a wide area network (WAN) such as the Internet, mobile network, or any other type of network) via a network adapter 1018.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A body visualization system, comprising:
a store of body images depicting a variety of body types;
a body image selector that obtains a body image from the store and displays the body image on a display; and
a body image manipulator that enables a user to visually alter the body image on the display.

2. The body visualization system of claim 1, wherein the body image selector selects the body image from the store in response to a set of descriptive parameters provided by the user.

3. The body visualization system of claim 1, wherein the descriptive parameters include a body weight.

4. The body visualization system of claim 1, wherein the descriptive parameters include a body height.

5. The body visualization system of claim 1, wherein the body image manipulator enables the user to alter one or more dimensions of one or more features of the body image.

6. The body visualization system of claim 1, wherein the body image manipulator enables the user to alter a face depicted on the body image.

7. The body visualization system of claim 1, wherein the body image manipulator enables the user to alter a hairstyle depicted on the body image.

8. The body visualization system of claim 1, wherein the body image manipulator enables the user to alter a skin tone depicted on the body image.

9. The body visualization system of claim 1, wherein the body image manipulator enables the user to add a wearable items onto the body image.

10. The body visualization system of claim 1, wherein the body image manipulator enables the user to alter a background depiction in the body image.

11. A method for body visualization, comprising:
providing a store of body images depicting a variety of body types;
selecting a body image from the store and displaying the body image to a user; and
obtaining a set of user inputs from the user and visually altering the body image in response to the user inputs.

12. The method of claim 11, wherein selecting a body image comprises selecting a body image from the store in response to a set of descriptive parameters provided by the user.

13. The method of claim 11, wherein the descriptive parameters include a body weight.

14. The method of claim 11, wherein the descriptive parameters include a body height.

15. The method of claim 11, wherein visually altering the body image comprises altering one or more dimensions of one or more features of the body image.

16. The method of claim 11, wherein visually altering the body image comprises altering a face depicted on the body image.

17. The method of claim 11, wherein visually altering the body image comprises altering a hairstyle depicted on the body image.

18. The method of claim 11, wherein visually altering the body image comprises altering a skin tone depicted on the body image.

19. The method of claim 11, wherein visually altering the body image comprises altering adding a wearable items onto the body image.

20. The method of claim 11, wherein visually altering the body image comprises altering a background depiction in the body image.
